(19) United States
(12) Patent Application Publication
(10) Pub. No.: US 2025/0253567 A1
(43) Pub. Date: Aug. 7, 2025

(54) CHAIN TERMINALS, CONNECTOR TERMINAL, CONNECTOR, AND METHOD FOR MANUFACTURING CONNECTOR TERMINALS

(71) Applicant: HIROSE ELECTRIC CO., LTD., Kanagawa (JP)

(72) Inventor: Shinnosuke MIWA, Kanagawa (JP)

(21) Appl. No.: 19/027,184

(22) Filed: Jan. 17, 2025

(30) Foreign Application Priority Data
Feb. 6, 2024 (JP) 2024-016299

(51) Int. Cl. H01R 13/04; H01R 13/422; H01R 43/16

(52) U.S. Cl. CPC H01R 13/04; H01R 13/422; H01R 43/16

(57) ABSTRACT

Provided are chain terminals that include: a plurality of connector terminals; and a band-shaped carrier coupling the connector terminals. In the chain terminals, each of the connector terminals includes: a base portion; a first contact portion protruding from the base portion toward one-direction side in a longitudinal direction of the connector terminal; and a second contact portion protruding from the base portion toward the other-direction side in the longitudinal direction of the connector. The carrier couples the base portions, which are adjacent to one another, of the connector terminals, in a row.

### CROSS-REFERENCE TO RELATED APPLICATION

This application claims priority from Japanese Patent Application No. 2024-016299 filed with the Japan Patent Office on Feb. 6, 2024, the entire content of which is hereby incorporated by reference.

### BACKGROUND

### 1. Technical Field

The present disclosure relates to chain terminals, a connector terminal, a connector, and a method for manufacturing connector terminals.

### 2. Related Art

A connector is known which is assembled by inserting a plurality of connector terminals into a plurality of terminal insertion holes provided to a housing of the connector. The plurality of connector terminals is coupled via a carrier. The plurality of connector terminals is separated from the carrier into individual connector terminals before or after being inserted into the plurality of terminal insertion holes. In terms of the connector terminal, a connector terminal having a pin-like contact portion at each of two ends thereof is known (refer to, for example, JP-A-2004-063101). In JP-A-2004-063101, one of the contact portions of the connector terminal is coupled to a carrier, and a distal end of the one of the contact portions is separated from the carrier after the other contact portion is inserted into a terminal insertion hole.

### SUMMARY

Chain terminals according to an embodiment of the present disclosure are configured to include: a plurality of connector terminals; and a band-shaped carrier coupling the connector terminals. In the chain terminals, each of the connector terminals includes: a base portion; a first contact portion protruding from the base portion toward one-direction side in a longitudinal direction of the connector terminal; and a second contact portion protruding from the base portion toward the other-direction side in the longitudinal direction of the connector. The carrier couples the base portions, which are adjacent to one another, of the connector terminals, in a row.

### BRIEF DESCRIPTION OF THE DRAWINGS

FIG. 1 is a perspective view of chain terminals of the embodiment;

FIG. 2 is a perspective view of a connector terminal of the embodiment;

FIGS. 3A to 3C are a plan view and cross-sectional views of a connector of the embodiment;

FIG. 4 is an explanatory view of a connector assembly operation of the embodiment; and

FIG. 5 is an explanatory view of a connected state of terminals of the embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in JP-A-2004-063101, when the connector terminal is separated from the carrier, for example, a burr may be formed on the one of the contact portions of the connector terminal, which may cause a contact failure and a connect/disconnect failure between the connector terminal and a mating connector terminal.

The present disclosure has been made in view of such a point, and an object thereof is to provide chain terminals, a connector terminal, a connector, and a method for manufacturing contactor terminals, which can prevent failures in contact and connect/disconnect with a mating connector terminal.

Chain terminals according to one aspect of the present disclosure includes: a plurality of connector terminals; and a band-shaped carrier coupling the connector terminals. Each of the connector terminals includes: a base portion; a first contact portion protruding from the base portion toward one-direction side in a longitudinal direction of the connector terminal; and a second contact portion protruding from the base portion toward the other-direction side in the longitudinal direction of the connector terminal. The carrier couples the base portions, which are adjacent to one another, of the connector terminals, in a row.

Regarding a connector terminal according to one aspect of the present disclosure, the carrier coupling the adjacent base portions of the chain terminals is cut to separate the connector terminal from the chain terminals and to form the base portion of the each of the connector terminals.

According to the one aspect of the connector terminal of the present disclosure, the carrier coupling the adjacent base portions of the chain terminals is cut to separate the connector terminal from the chain terminals and to form the base portion of each connector terminal. Upon cutting the carrier, burrs and cutting failures are not caused on the first and second contact portions. Therefore, it is possible to prevent contact and connect/disconnect failures between the connector terminal and a mating connector terminal.

Generally, chain terminals are formed by connecting a plurality of terminals with a band-shaped carrier. The terminals are separated from the carrier to be used. When the terminals are separated from the carrier, burrs may be formed on cut surfaces of the terminals, or the cut surfaces may be slanted. If places that are coupled by the carrier are leads of a DIP terminal, the leads are soldered to a board. Therefore, even if, for example, burrs are formed on the cut surfaces of the leads to some extent, it has only a slight influence. On the other hand, if places that are coupled by the carrier are contact portions of pin terminals, for example, burrs on the broken-out sections of the contact portions may cause contact and connect/disconnect failures upon connection with mating connector terminals.

As long as central portions of the plurality of terminals are coupled by the center carrier, even if the center carrier is cut, for example, burrs are not formed on distal ends of the contact portions. However, the center carrier has a band shape with a predetermined thickness; therefore, a load that acts on a cutting tool upon cutting of the center carrier is heavy. The center carrier includes a plurality of carrier holes for feeding the chain terminals. In the embodiment, the carrier holes are created in the canter carrier to reduce the strength of the center carrier in the places to be cut and reduce the load acting on the cutting tool.

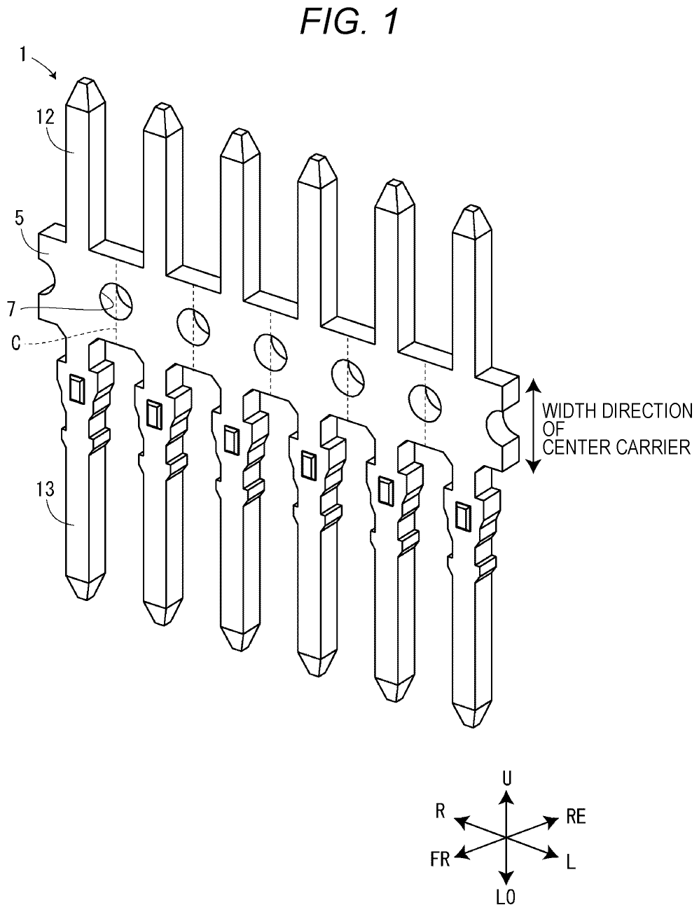

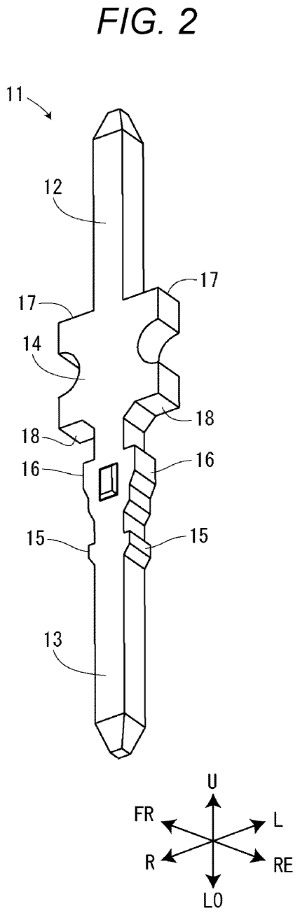

Chain terminals and a connector terminal of the embodiment are described below. FIG. 1 is a perspective view of the chain terminals of the embodiment. FIG. 2 is a perspective view of the connector terminal of the embodiment. Note that in the drawings, an arrow FR indicates the front side of the terminal, an arrow RE indicates the rear side of the terminal, an arrow U indicates the upper side of the terminal, an arrow LO indicates the lower side of the terminal, an arrow L indicates the left side of the terminal, and an arrow R indicates the right side of the terminal.

As illustrated in FIG. 1, chain terminals 1 are formed by blanking a metal flat plate into a predetermined shape. The chain terminals 1 are provided with a band-shaped carrier (center carrier 5) having a plurality of terminals (connector terminals 11) connected in a row. In other words, the chain terminals 1 include the plurality of connector terminals 11, and the band-shaped center carrier 5 that couples the plurality of connector terminals 11.

As illustrated in FIG. 2, each of the connector terminals 11 includes a base portion 14, a first contact portion 12, and a second contact portion 13.

The first contact portion 12 of each terminal of the chain terminals 1 protrudes from an upper edge of the center carrier 5, and the second contact portion 13 of the each terminal protrudes from a lower edge of the center carrier 5. The first contact portions 12 of the terminals are aligned, spaced evenly, in an extension direction of the center carrier 5. The second contact portions 13 of the terminals are aligned, spaced evenly, in the extension direction of the center carrier 5 in such a manner as to correspond to the first contact portions 12 respectively.

The connecter terminals 11 are formed by being separated from the chain terminals 1. The base portions 14 of the connector terminals 11 are formed by cutting the center carrier 5 that couples the connector terminals 11 adjacent to one another when the connector terminals 11 are separated from the chain terminals 1.

To be more specific, the center carrier 5 couples, in a row, the base portions 14, which are adjacent to one another, of the plurality of connector terminals 11 of the chain terminals 1. The center carrier 5 that couples the adjacent base portions 14 of the chain terminals 1 is cut to separate each connector terminal 11 from the chain terminals 1 and form the base portion 14 of the each connector terminal 11.

A plurality of carrier holes 7 for feeding the chain terminals 1 is formed in the center carrier 5. The chain terminals 1 include the carrier holes 7 in portions where in the center carrier 5 the adjacent connecter terminals 11 are coupled. To be more specific, the carrier holes 7 are provided in portions where in the center carrier 5 the adjacent base portions 14 are coupled.

The carrier holes 7 penetrate the center carrier 5 in a thickness direction thereof. The carrier holes 7 each have a circular shape, and are configured in such a manner as to allow a feed claw of a transfer mechanism (not illustrated) to enter the carrier holes 7 to feed the chain terminals 1. The carrier holes 7 are located (on the boundary) between the adjacent connector terminals 11 before the connector terminals 11 are separated from the chain terminals 1. When the connecter terminals 11 are separated from the chain terminals 1, the center carrier 5 is cut in such a manner as to cross the carrier holes 7 in an up-and-down direction.

In the example illustrated in FIG. 1, a planned cut line C is set on the center carrier 5 in such a manner as to cross a center position of each of the carrier holes 7 in a width direction of the center carrier 5 (the up-and-down direction). In this case, the center carrier 5 is cut along the planned cut lines C that cross the center positions of the carrier holes 7. Hence, a width required to cut the center carrier 5 with a cutting tool (a cut width) can be reduced by the diameter of the carrier holes 7.

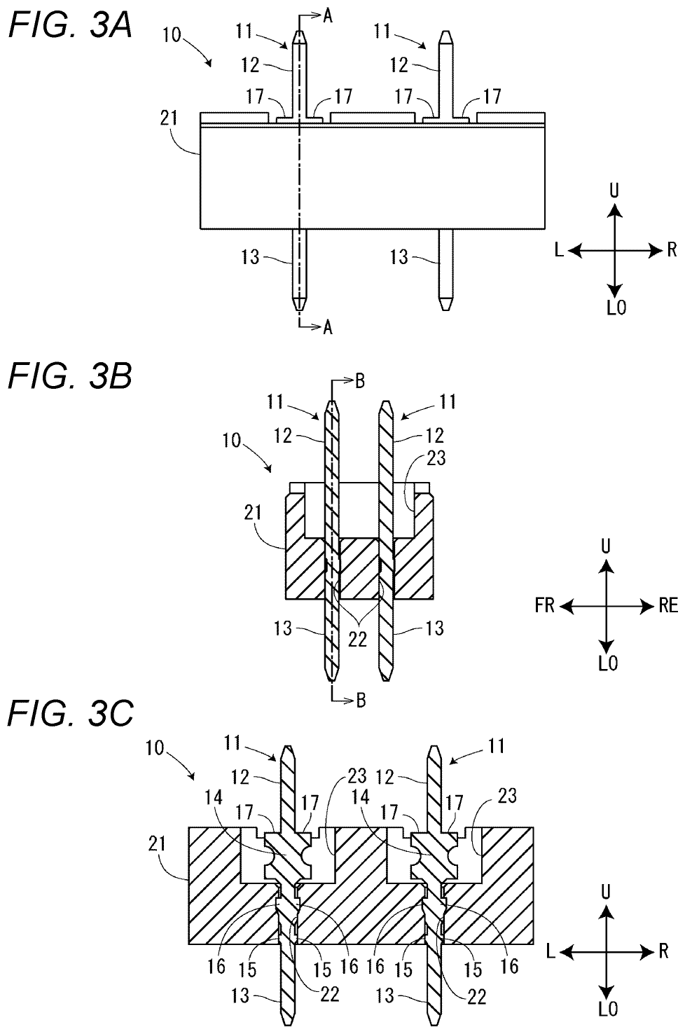

As illustrated in FIG. 2, the connector terminal 11 is formed by being separated from the chain terminals 1. The connector terminal 11 is inserted into a terminal insertion hole 22 of a connector housing 21 (refer to FIGS. 3A to 3C) to assemble a connector. The wide base portion 14 is formed in the middle of the connector terminal 11. The base portion 14 is mounted on the connector housing 21. The first contact portion 12 protrudes upward (in a first direction) from the base portion 14. The second contact portion 13 protrudes downward (in a second direction) from the base portion 14. The first contact portion 12 and the second contact portion 13 each have a prism shape, and their distal ends are tapered to a truncated pyramid shape. Note that in the following description, upward (the first direction) and downward (the second direction) may be referred to as one-direction side and the other-direction side in a longitudinal direction of the connecter terminal 11.

A proximal end side (upper side) of the second contact portion 13 is inserted into the terminal insertion hole 22 of the connector housing 21. The second contact portion 13 includes a pair of first locking claws 15 and a pair of second locking claws 16. The pair of first locking claws 15 and the pair of second locking claws 16 extend in a left-and-right direction of the connector terminal 11 from two side surfaces of the proximal end side (upper side) of the second contact portion 13. The first locking claws 15 are located below the second locking claws 16. A side surface of each first locking claw 15 is inclined in such a manner as to increase the amount of extension gradually toward the proximal end. A side surface of each second locking claw 16 is inclined in stages in such a manner as to increase the amount of extension gradually toward the proximal end. Consequently, the second contact portion 13 can be press-fitted into the terminal insertion hole 22. Moreover, it is possible to make it hard for the second contact portion 13 to come out of the terminal insertion hole 22.

The base portion 14 of the connector terminal 11 is formed by cutting the center carrier 5 (refer to FIG. 1) and separating the connector terminal 11 from the chain terminals 1. As described above, the carrier hole 7 is formed on the planned cut line C on the center carrier 5; therefore, the cut width to be cut by the cutting tool is reduced by the dimension of the carrier hole 7, and the load acting on the cutting tool is reduced. Moreover, burrs and cutting failures may be caused on the cut surfaces of the center carrier 5, that is, the side surfaces of the base portions 14. The side surfaces of the base portion 14 do not come into contact with the connector housing 21 and a mating connector terminal; therefore, the formation of, for example, burrs on the side surfaces of the base portion 14 has no influence.

The separation of the connector terminal 11 from the chain terminals 1 results in formation of a pair of press-fitting shoulders 17 on a top surface on a first contact portion 12 side of the base portion 14 and formation of a pair of abutment surfaces 18 on an undersurface on a second contact portion 13 side of the base portion 14. The pair of press-fitting shoulders 17 and the pair of abutment surfaces 18 are formed in such a manner as to extend in the left-and-right direction of the connector terminal 11. The pair of press-fitting shoulders 17 is a pair of pressure-receiving surfaces that receives pressure from a pressing tool (not illustrated), and the pair of press-fitting shoulders 17 is pressed by the pressing tool to insert the second contact portion 13 into the terminal insertion hole 22. The pair of abutment surfaces 18 comes into contact with a bottom surface of the connector housing 21 to restrict the amount of insertion of the connector terminal 11. In this manner, the center carrier 5 is used to form the pair of press-fitting shoulders 17 and the pair of abutment surfaces 18 on the connector terminal 11.

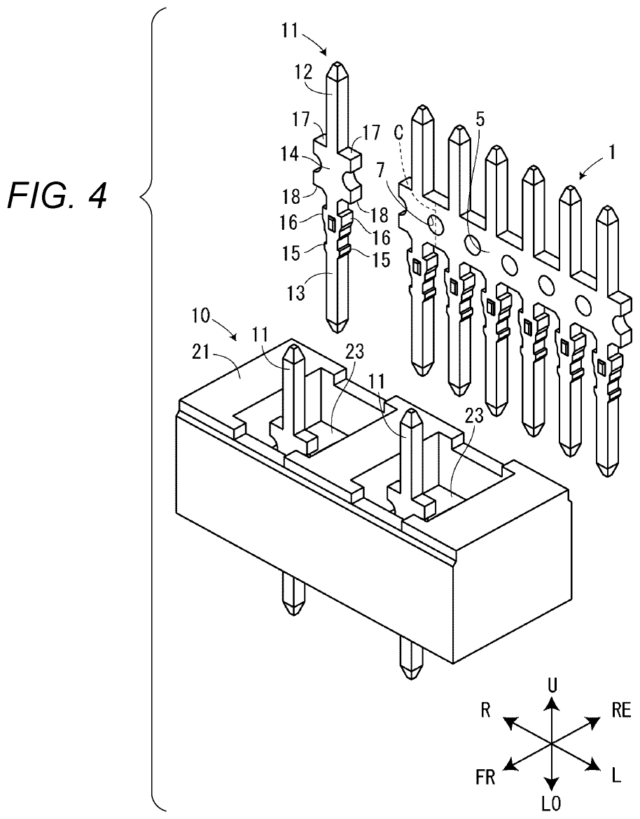

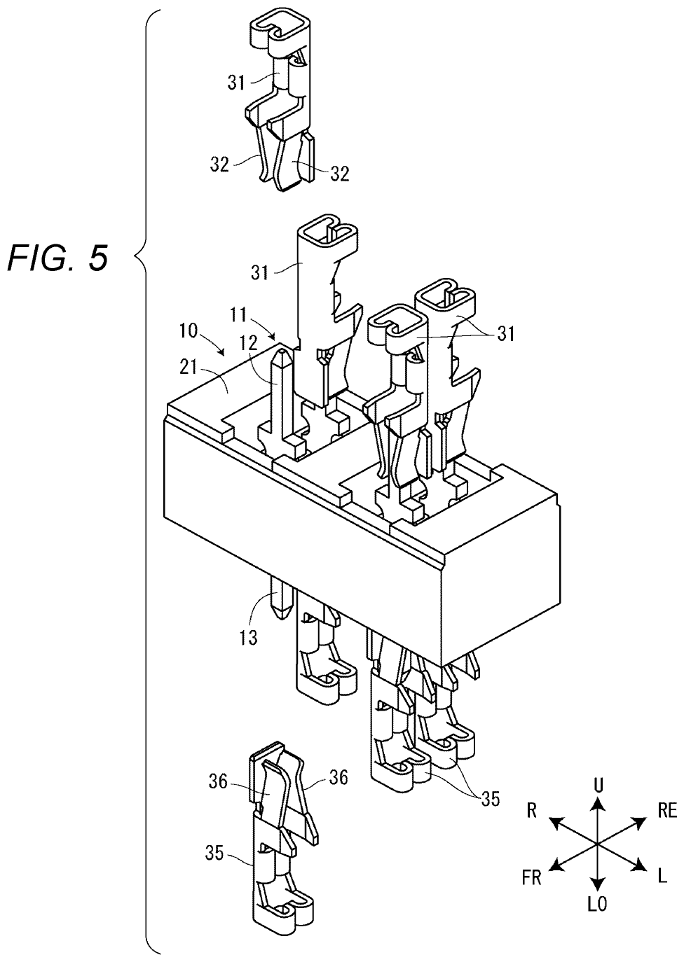

The connector and a method for assembling the connector are described with reference to FIGS. 3A to 5. FIGS. 3A to 3C are a plan view and cross-sectional views of the connector of the embodiment. FIG. 4 is an explanatory view of a connector assembly operation of the embodiment. FIG. 5 is an explanatory view of a connected state of the terminals of the embodiment. Note that FIG. 3A illustrates the connector in plan view, FIG. 3B illustrates the connector of FIG. 3A in cross section taken along line A-A, and FIG. 3C illustrates the connector of FIG. 3B in cross section taken along line B-B. Moreover, a housing of a mating connector is omitted in FIG. 5.

As illustrated in FIGS. 3A to 3C, a connector 10 is a relay connector that connects a pair of mating connectors (not illustrated). The connector 10 includes the resin connector housing 21. A pair of left and right recessed portions 23 is formed in a top surface of the connector housing 21. A pair of front and rear terminal insertion holes 22 penetrates from a bottom surface of each of the recessed portions 23 to an undersurface of the connector housing 21. The second contact portion 13 of each connector terminal 11 is press-fitted in its respective terminal insertion hole 22. The first contact portion 12 of the each connector terminal 11 protrudes upward from the top surface of the connector housing 21, and the second contact portion 13 of the each connector terminal 11 protrudes downward from the undersurface of the connector housing 21.

In a case of the embodiment, the recessed portions 23 are designed in such a manner that their depth dimension is greater than a height dimension of the base portions 14. More specifically, the top surface of the connector housing 21 is located above the pairs of press-fitting shoulders 17 of the base portions 14. The base portions 14 fit completely in the recessed portions 23. Therefore, even if the mating connector is connected to the first contact portions 12 of the connector 10, the pairs of press-fitting shoulders 17 do not interfere with the mating connector. Moreover, the base portions 14 extend sidewards further than the second locking claws 16. Hence, undersurfaces of the base portions 14 function as the abutment surfaces 18 that come into contact with the bottom surfaces of the recessed portions 23.

Next, the manufacture of the connector terminals 11 and the assembly of the connector 10 are described. As illustrated in FIG. 1, a flat plate made of metal such as phosphor bronze is blanked into a predetermined shape to form the chain terminals 1 (a step of forming the chain terminals 1). The chain terminals 1 are blanked out from the metal flat plate. Next, the chain terminals 1 undergo plating such as base plating. The plated chain terminals 1 are loaded into the production line. In the production line, the feed claw hooks the carrier holes 7 of the center carrier 5 sequentially to feed the chain terminals 1 toward the cutting tool.

Next, as illustrated in FIG. 4, the chain terminals 1 are cut to separate the connector terminal 11 from the chain terminals 1 (a step of separating the connector terminal 11). In the embodiment, the center carrier 5 is cut along the planned cut line C with the cutting tool to separate the connector terminal 11 from the chain terminals 1. Consequently, the base portion 14, which includes the pair of press-fitting shoulders 17 and the pair of abutment surfaces 18, of each connector terminal 11 is formed. As described above, the carrier holes 7 are formed in the center carrier 5. Therefore, the cut width of the center carrier 5 is reduced by the diameter of the carrier holes 7, and resistance is reduced when the center carrier 5 is cut by the cutting tool. The cut surfaces of the each connector terminal 11 are not plated, and the base material such as phosphor bronze is exposed from the cut surfaces.

Next, the connector terminal 11 is placed above the connector housing 21 and inserted by the pressing tool into the terminal insertion hole 22 (refer to FIG. 3C) of the connector housing 21. At this point in time, the pressing tool is brought into contact with the pair of press-fitting shoulders 17 of the connector terminal 11 to press the second contact portion 13 of the connector terminal 11 into the terminal insertion hole 22 of the connector housing 21. When the pair of abutment surfaces 18 of the connector terminal 11 comes into contact with the bottom surface of the recessed portion 23 of the connector housing 21, the press of the pressing tool is stopped. The second contact portion 13 is press-fitted into the terminal insertion hole 22, and the first locking claws 15 and the second locking claws 16 of the second contact portion 13 bite into an inner surface of the terminal insertion hole 22 to prevent the connector terminal 11 from coming out.

As illustrated in FIG. 5, a mating connector terminal 31 is brought close to the first contact portion 12 of the connector terminal 11, and the first contact portion 12 of the connector terminal 11 enters between a pair of contact pieces 32 of the connector terminal 31. The first contact portion 12 is sandwiched between the pair of contact pieces 32, and the connector terminal 11 and the mating connector terminal 31 are connected together. Moreover, a mating connector terminal 35 is brought close to the second contact portion 13 of the connector terminal 11, and the second contact portion 13 of the connector terminal 11 enters between a pair of contact pieces 36 of the connector terminal 35. The second contact portion 13 is sandwiched between the pair of contact pieces 36, and the connector terminal 11 and the mating connector terminal 35 are connected together.

As described above, the connector terminal 11 is cut at the center carrier 5. Therefore, burrs and cutting failures are not caused on the distal ends of the first contact portion 12 and the second contact portion 13. Hence, the first contact portion 12 of the connector terminal 11 comes into good contact with the pair of contact pieces 32 of the mating connector terminal 31. The second contact portion 13 of the connector terminal 11 comes into good contact with the pair of contact pieces 36 of the mating connector terminal 35. The mating connector terminals 31 and 35 are connected to various wires such as a power line and a signal line. The various wires connected to the mating connector terminals 31 and 35 are electrically connected via the connector terminal 11.

As described above, according to the embodiment, the center carrier 5 of the chain terminals 1 is cut and therefore the connecter terminals 11 are separated from the chain terminals 1, and the base portions 14 of the connector terminals 11 are formed. Burrs and cutting failures are not caused on the first contact portions 12 and the second contact portions 13 when the center carrier 5 is cut. Therefore, it is possible to prevent contact and connect/disconnect failures between the connector terminals 11 and the mating connector terminals 31 and 35.

Note that in the embodiment, the first contact portions 12 and the second contact portions 13 each have a prism shape. However, the first contact portions 12 and the second contact portions 13 are simply required to be formed in such a manner as to protrude from the base portions 14, and their shapes are not particularly limited.

Moreover, in the embodiment, the carrier holes 7 each have a circular shape. However, the hole shape of the carrier holes 7 is not particularly limited.

Moreover, in the embodiment, the connector terminals 11 are separated from the chain terminals 1, and then inserted into the connector housing 21. However, the connector terminals 11 may be inserted into the connector housing 21, and then separated from the chain terminals 1.

Chain terminals (1) according to a first aspect of the present disclosure includes: a plurality of connector terminals (11); and a band-shaped carrier (center carrier 5) coupling the connector terminals. Each of the connector terminals includes: a base portion (14); a first contact portion (12) protruding from the base portion toward one-direction side in a longitudinal direction of the connector terminal; and a second contact portion (13) protruding from the base portion toward the other-direction side in the longitudinal direction of the connector terminal. The carrier couples the base portions, which are adjacent to one another, of the connector terminals, in a row.

A second aspect of the present disclosure is the chain terminals (1) according to the first aspect, in which the chain terminals include carrier holes (7) for feeding the chain terminals in portions where in the carrier the adjacent base portions are coupled, and the connector terminals are configured to be separated from the chain terminals by cutting the carrier in such a manner as to cross the carrier holes in an up-and-down direction. According to this configuration, the cut width to be cut by a cutting tool can be reduced by the dimension of the carrier holes. Therefore, a load that acts on the cutting tool when the carrier is cut can be reduced.

A third aspect of the present disclosure is a connector terminal (11), in which the carrier coupling the adjacent base portions of the chain terminals according to the first or second aspect is cut to separate the connector terminal from the chain terminals and to form the base portion of the each of the connector terminals. According to this configuration, the carrier of the chain terminals is cut to separate the connector terminal from the chain terminals and to form the base portion of the connector terminal. Burrs and cutting failures are not caused on the first and second contact portions when the carrier is cut. Therefore, it is possible to prevent contact and connect/disconnect failures between the connector terminal and a mating connector terminal.

A fourth aspect of the present disclosure is that, in the third aspect, the base portion includes a pair of press-fitting shoulders (17) on a first contact portion side of the base portion, and the pair of press-fitting shoulders is formed in such a manner as to extend in a left-and-right direction of the connector terminal. According to this configuration, the press-fitting shoulders that receive pressing force from a pressing tool can be formed by use of the carrier of the chain terminals.

A fifth aspect of the present disclosure is that, in the third or fourth aspect, the second contact portion includes a pair of locking claws (15, 16), the pair of locking claws is formed in such a manner as to extend in a left-and-right direction of the connector terminal from two side surfaces on a proximal end side of the second contact portion, and a side surface of each of the pair of locking claws is inclined in such a manner as to increase the amount of extension gradually toward the proximal end side of the second contact portion.

A sixth aspect of the present disclosure is a connector (10) including: the connector terminal according to the third aspect; and a connector housing, in which the connector housing is configured in such a manner that the base portion is mounted thereon, and the connector housing includes a terminal insertion hole into which the connector terminal is inserted. According to this configuration, it is possible to prevent contact and connect/disconnect failures between the connector terminal and a mating connector terminal when the connectors are connected together.

A seventh aspect of the present disclosure is that, in the sixth aspect, the base portion includes a pair of press-fitting shoulders on a first contact portion side of the base portion, the pair of press-fitting shoulders is formed in such a manner as to extend from two side surfaces of the first contact portion in a left-and-right direction of the connector terminal, and the connector terminal is configured in such a manner that the second contact portion is inserted into the terminal insertion hole of the connector housing by pressing the pair of press-fitting shoulders from the one-direction side toward the other-direction side in the longitudinal direction. According to this configuration, the press-fitting shoulders are pressed by a pressing tool. Therefore, the connector terminal can be easily inserted into the terminal insertion hole of the connector housing.

An eighth aspect of the present disclosure is that, in the sixth or seventh aspect, the second contact portion includes a pair of locking claws, the pair of locking claws is formed in such a manner as to extend from two side surfaces on a proximal end side of the second contact portion in a left-and-right direction of the connector terminal, a side surface of each of the pair of locking claws is inclined in such a manner as to increase the amount of extension gradually toward the proximal end side of the second contact portion, and the proximal end side of the second contact portion is configured to be inserted into the terminal insertion hole of the connector housing. According to this configuration, it is possible to press-fit the second contact portion into the terminal insertion hole and to make it hard for the second contact portion to come out of the terminal insertion hole.

A ninth aspect of the present disclosure is a method for manufacturing a plurality of connector terminals including: blanking a flat plate into a predetermined shape to form chain terminals; and separating each of the connector terminals from the chain terminals, in which each of the chain terminals includes: the connector terminals; and a band-shaped carrier coupling the connector terminals, each of the connector terminals includes: a base portion; a first contact portion protruding from the base portion toward one-direction side in a longitudinal direction of the connector terminal; and a second contact portion protruding from the base portion toward the other-direction side in the longitudinal direction of the connector terminal, the carrier couples the base portions, which are adjacent to one another, of the connector terminals, in a row, and upon separating each of the connector terminals from the chain terminals, the carrier coupling the adjacent base portions is cut to form the base portion of the each of the connector terminals. According to this configuration, it is possible to manufacture the connector terminals that can prevent contact and connect/disconnect failures between the connector terminals and mating connector terminals.

Note that the present disclosure is not limited to the above embodiment, and all or parts of the above embodiment and modifications may be combined.

Moreover, the technology of the present disclosure is not limited to the above embodiment, and may undergo various modifications, replacements, and deformations without departing from the purport of the technical idea. Furthermore, if the technical idea can be achieved by other methods with the advance of technology or other derivative technologies, the other methods may be implemented. Therefore, the scope of claims covers all embodiments that can be included in the scope of the technical idea.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. Chain terminals comprising:
a plurality of connector terminals; and
a band-shaped carrier coupling the connector terminals, wherein
each of the connector terminals includes:
a base portion;
a first contact portion protruding from the base portion toward one-direction side in a longitudinal direction of the connector terminal; and
a second contact portion protruding from the base portion toward the other-direction side in the longitudinal direction of the connector terminal, and
the carrier couples the base portions, which are adjacent to one another, of the connector terminals, in a row.

2. The chain terminals according to claim 1, wherein
the chain terminals comprise carrier holes for feeding the chain terminals in portions where in the carrier the adjacent base portions are coupled, and
the connector terminals are configured to be separated from the chain terminals by cutting the carrier in such a manner as to cross the carrier holes in an up-and-down direction.

3. A connector terminal wherein the carrier coupling the adjacent base portions of the chain terminals according to claim 1 is cut to separate the connector terminal from the chain terminals and to form the base portion of the each of the connector terminals.

4. The connector terminal according to claim 3, wherein
the base portion includes a pair of press-fitting shoulders on a first contact portion side of the base portion, and
the pair of press-fitting shoulders is formed in such a manner as to extend in a left-and-right direction of the connector terminal.

5. The connector terminal according to claim 3, wherein
the second contact portion includes a pair of locking claws,
the pair of locking claws is formed in such a manner as to extend in a left-and-right direction of the connector terminal from two side surfaces on a proximal end side of the second contact portion, and
a side surface of each of the pair of locking claws is inclined in such a manner as to increase the amount of extension gradually toward the proximal end side of the second contact portion.

6. A connector comprising:
the connector terminal according to claim 3; and
a connector housing, wherein
the connector housing is configured in such a manner that the base portion is mounted thereon, and
the connector housing includes a terminal insertion hole into which the connector terminal is inserted.

7. The connector according to claim 6, wherein
the base portion includes a pair of press-fitting shoulders on a first contact portion side of the base portion,
the pair of press-fitting shoulders is formed in such a manner as to extend from two side surfaces of the first contact portion in a left-and-right direction of the connector terminal, and
the connector terminal is configured in such a manner that the second contact portion is inserted into the terminal insertion hole of the connector housing by pressing the pair of press-fitting shoulders from the one-direction side toward the other-direction side in the longitudinal direction.

8. The connector according to claim 6, wherein
the second contact portion includes a pair of locking claws,
the pair of locking claws is formed in such a manner as to extend from two side surfaces on a proximal end side of the second contact portion in a left-and-right direction of the connector terminal,
a side surface of each of the pair of locking claws is inclined in such a manner as to increase the amount of extension gradually toward the proximal end side of the second contact portion, and
the proximal end side of the second contact portion is configured to be inserted into the terminal insertion hole of the connector housing.

9. A method for manufacturing a plurality of connector terminals comprising:
blanking a flat plate into a predetermined shape to form chain terminals; and
separating each of the connector terminals from the chain terminals, wherein
each of the chain terminals includes:
the connector terminals; and
a band-shaped carrier coupling the connector terminals, each of the connector terminals includes:
a base portion;
a first contact portion protruding from the base portion toward one-direction side in a longitudinal direction of the connector terminal; and
a second contact portion protruding from the base portion toward the other-direction side in the longitudinal direction of the connector terminal,
the carrier couples the base portions, which are adjacent to one another, of the connector terminals, in a row, and
upon separating each of the connector terminals from the chain terminals, the carrier coupling the adjacent base portions is cut to form the base portion of the each of the connector terminals.
